(19) United States
(12) Patent Application Publication
(10) Pub. No.: US 2012/0296597 A1
(43) Pub. Date: Nov. 22, 2012

(54) METHODS AND SYSTEMS FOR DISTRIBUTING EQUIPMENT AND ADAPTERS FOR ELECTRICAL HARNESS TESTING

(75) Inventor: DAVID ALAN SHIER, SOLVANG, CA (US)

(73) Assignee: CK Technologies, Inc.

(21) Appl. No.: 13/299,270

(22) Filed: Nov. 17, 2011

Related U.S. Application Data
(60) Provisional application No. 61/415,317, filed on Nov. 18, 2010.

(51) Int. Cl. G06F 19/00; G06G 7/48

(52) U.S. Cl. 702/123; 703/6

(57) ABSTRACT

Methods and systems for distributing equipment and adapters for electrical harness testing. Embodiments of the present invention provide a computer aided design (CAD) automated method of arranging test equipment elements and determining test adapter cable lengths based on the physical locations of the test nodes in the unit under test. Using these methods/systems, test setups may be quickly evaluated.

### RELATED APPLICATION

This application claims the benefit of U.S. Provisional Patent Application No. 61/415,317 filed on Nov. 18, 2010.

### BACKGROUND OF THE INVENTION

1. Field of the Invention

The invention relates to electrical harness testing and, more particularly, to methods for efficient distribution of equipment and adapters for testing.

2. Description of the Related Art

Automated wiring harness test systems have long been known and widely used in aerospace and other industries for testing electrical harnesses and related subassemblies. In many cases the distribution of the termination points in the unit under test (UUT), which includes the wire harness or the electrical assembly up to and including a complete aircraft system, for example, is physically large. In such applications, the test stimulus and measurement switching hardware is often placed in multiple enclosures that are remote from the test system control hardware and closer to the UUT connections. Thus, it has been necessary for the test engineer to determine the best locations for the switching hardware by means of trial and error.

The connections between the UUT connectors and the tester switching units (SUs) are made using wire harnesses dedicated to the test process known as test adapter cables (TACs) or other similar terms such as harness adapter cables, etc.

Various computer assisted design (CAD) tools have been developed that can determine the specific routing of harnesses given known physical locations of the end connectors on the harnesses. While such tools may be applied to TAC design, the user must first determine the location of the tester units. However, since the placement of the tester units is dependent on the “best fit” of the TACs to the various tester units, this creates a design impasse that can result in a less than optimal test system layout.

Still other tools have been designed for generating test data and designing the test adapter cabling. However, these tools do not provide physical routing information. Rather, they require the user to determine the needed cable lengths independent of the tool and input that information as a parameter for the cable design.

Thus, there is a need for methods/systems capable of designing the layout of the tester system and determining the lengths of the TACs.

### BRIEF DESCRIPTION OF THE DRAWINGS

FIG. 1 is a diagram of switching unit and adapter placement according to an embodiment of the present invention.

FIG. 2 is a diagram of switching unit and adapter placement according to an embodiment of the present invention.

FIG. 3 is a diagram of switching unit and adapter placement according to an embodiment of the present invention.

FIG. 4 is a diagram of switching unit and adapter placement according to an embodiment of the present invention.

FIG. 5 is a perspective view of a portion of an aircraft fuselage and various elements therein according to an embodiment of the present invention.

FIG. 6 is a plan view of a switching unit and several adapter connectors according to an embodiment of the present invention.

FIG. 7 is a flow chart showing a method of determining the arrangement of a plurality of SUs and a plurality of UUT connectors within an aircraft fuselage according to an embodiment of the present invention.

### DETAILED DESCRIPTION OF THE INVENTION

Embodiments of the invention are described herein with reference to schematic illustrations. As such, the actual shapes of elements are not represented, and variations from the shapes of the illustrations are expected. Thus, the elements illustrated in the figures are schematic in nature and their shapes are not intended to illustrate the precise shape of a region of a device and are not intended to limit the scope of the invention.

It is understood that when an element is referred to as being “on” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one element to another. It is understood that these terms are intended to encompass different orientations in addition to the orientation depicted in the figures.

Although the ordinal terms first, second, etc., may be used herein to describe various objects, components, regions and/or sections, these objects, components, regions, and/or sections should not be limited by these terms. These terms are only used to distinguish one object, component, region, or section from another. Thus, unless expressly stated otherwise, a first object, component, region, or section discussed below could be termed a second object, component, region, or section without departing from the teachings of the present invention.

It will be understood that although embodiments of methods described herein are described as comprising various steps, these steps should not be limited to any particular order unless expressly stated otherwise or logically required.

Embodiments of the present invention provide methods/systems for determining a test system layout and simultaneously determining the test adapter cable lengths via a point clustering technique. In many embodiments of the invention, a modified K-Means clustering algorithm is used. However, it is understood by those skilled in the art that many other clustering algorithms can be utilized to achieve a similar result.

In one embodiment, a three-dimensional X-Y-Z coordinate system mapping the UUT mating connector locations is utilized to determine an optimized location for each SU and the UUT mating connectors that should be assigned to each SU. Given the determined SU location and the UUT connector location, the lengths of the various test adapter cables can also be calculated.

One coordinate system convention often used for vehicles, including aircraft, is based on an X-Y-Z system. The coordinate systems are discussed herein with a focus on aircraft, although it is understood that the coordinate system can be applied to many different vehicles and, indeed, other spaces not related to vehicles such as the interior space of a building, for example. Indeed, in a general sense, embodiments of the present invention may be used to arrange any associated objects (e.g., first- and second-type objects) within any 3D space.

In the particular case of an aircraft system, the X-axis is positive pointing aft and is typically called the station line or fuselage station (FS). The origin, or “0 station” is either at the nose of the aircraft, or more often, at some arbitrary point forward of the nose such that future extensions of the airframe do not cause the nose to extend past 0 into negative station numbers. The Y-axis is usually called the butt line (BL) with the origin being at the centerline of the vehicle and positive pointing toward the aircraft's right wing and negative toward the left wing. The Z-axis is known as the water line (WL) and is positive pointing upward. As with the station, the origin is either at ground level (with the landing gear in the down position) or more often, an arbitrary distance below the extended landing gear. In the United States, the distances are typically shown in inches. However, embodiments of the invention can operate on unitless coordinates since, as long as all dimensional data is provided in the same unit of measure, the units can be ignored for calculation purposes.

In many cases, named zones are provided rather than dimensional coordinates in indicating the location of components within the UUT. A separate listing of the physical location of each zone is provided to the test engineers. While, for the purpose of clarity, only the X-Y-Z coordinate system shall be detailed here, other embodiments allow for the use of a mapping lookup table that converts named zones to their respective X-Y-Z locations.

In some embodiments, a modified K-Means clustering algorithm is used to determine the assignment of UUT end connectors to each tester SU as well as to determine the location of the SUs. However, as noted herein it is understood by those skilled in the art that many other clustering algorithms can be utilized to achieve a similar result.

A K-Means clustering algorithm is particularly suited to embodiments of the present invention. It is understood that various limitations of K-Means clustering when used in other applications prove to be either of minor significance, or even advantageous, in its application to embodiments discussed herein. Specifically, the following limitations have been discussed in academic literature regarding K-Means clustering.

One often-cited limitation is that the algorithm depends on the initial choices for the cluster centers. This is of minor significance since the number of tester units is generally quite small and, due to the speed of the algorithm, the user has an opportunity to test various possible initial conditions.

Another consideration is that outlying points will have a large effect on the center of the cluster. This actually proves to be an advantage because, rather than attempting to create patterns, one important goal is to minimize the total test cable length. Using the mean of the cluster rather than, for example, a median connector in the cluster provides a better solution.

Another cited limitation is that K-Means techniques do not recognize patterns in the items being clustered. While disadvantageous in some other applications, this feature of a K-Means algorithm is useful as the goal is to minimize cable lengths rather than to create clusters of like items. However, in some embodiments of the invention, a “weight factor” can be added for attributes such as aircraft zone names. This would allow grouping of connectors by zone when practical.

In some applications, K-Means is not massively scalable since the number of calculations increases exponentially with the number of items and/or clusters. However, in application to embodiments of the present invention this limitation has no practical impact because the number of UUT connectors in even the most complex aircraft is less than 10⁴ while the number of tester units is less than 10³, both of which are relatively small quantities when compared to the number of items in other kinds of systems.

Some embodiments of the invention comprise an input module configured to receive as input the locations of the UUT end connectors as well as an initial placement of the test system SUs. The distance from each UUT end connector to each SU is then calculated and the UUT connectors are temporarily assigned to the closest SU. The difference between the distance to the nearest SU and the next nearest SU is also recorded for each UUT connector for possible use in further calculations. All of these calculations can be done, for example, in a calculation module.

Since each SU has a finite capacity (i.e., a maximum number of available connections), there may be more UUT connectors assigned than can be accommodated. The connectors that have the smallest delta distance between the nearest and next nearest SU are transferred to the next nearest SU if that unit is not at or above its own capacity. The transfers continue until the first unit is within its capacity. Then the other SUs are tested for exceeding capacity, and the process is repeated. This process is not reiterative since it is possible that there are more UUT connections than the total capacity of all SUs, and, given that the overall algorithm is reiterative, at no point should it assume that the SU locations are final. In some embodiments, named zones can be used to ensure that all connectors in a single zone are moved as a group from one SU to another.

Once all the UUT connectors have been assigned to an SU, each SU is relocated to the center (centroid) of the cluster of all UUT connectors assigned to it.

The complete algorithm is then repeated recursively until no SUs require significant movement to be placed in the center of the clusters.

The user may then manually adjust the final SU locations to account for various practical limitations to their placement, such as the positioning of work platforms or obstacles, for example. Manual adjustments can occur in two stages. In the first stage, the UUT connector assignments are recalculated to assign connectors to the nearest SU. In the second stage, the user indicates that they are satisfied with the assignments and further SU movement simply recalculates the distance to the assigned unit without reassignment of any connectors to any other SU.

In most instances, the SU test adapter connectors themselves have a finite number of contacts which limit the number of UUT connectors assigned to them. Thus, the embodiments of the method can be applied at a more granular level to the connections to each connector on each SU just as it is applied to each SU within the test system as a whole.

Embodiments also include processing of physical obstacles in the UUT such as, for example, floors, walls and bulkheads that do not allow cables to pass from one side to the other. Other physical limitations may also be accounted for. In one embodiment, UUT connectors are only allowed to be assigned to SUs that are on the same side of all obstacles as themselves.

In one embodiment of the invention, obstacles are assumed to be infinite planes parallel to the X, Y or Z axes. However, it is clear to one of skill in the art that more complex obstacle geometries are possible such as 2-D or 3-D polygons and 3-D surfaces such as, for example, conical sections and spherical sections.

Some embodiments may utilize “taxicab geometry.” In taxicab geometry distances are measured based on following a strict X-Y grid rather than a straight line potentially crossing a diagonal vector. This geometry is so named as a taxicab moving from one point in a city to another must follow the grid of streets rather than cutting across the middle of the city blocks. Taxicab geometry may also be applied to 3-dimensional space by following only lines parallel to the X, Y, and Z axes. In this particular embodiment, the final distances between UUT connectors and SUs is calculated using taxicab geometry in order to account for the physical constraints of routing electrical cables across floors and vertically rather than creating an inaccessible array of cables routed in all directions. This also allows for additional cable length that may be necessary to route around physical obstacles that might appear in the test environment.

Various embodiments of the invention provide for user control and reporting either by tables of X-Y-Z coordinates or in a graphical representation of the 3D model. Embodiments of the present invention may be embodied in a computer readable medium or in pre-programmed hardware.

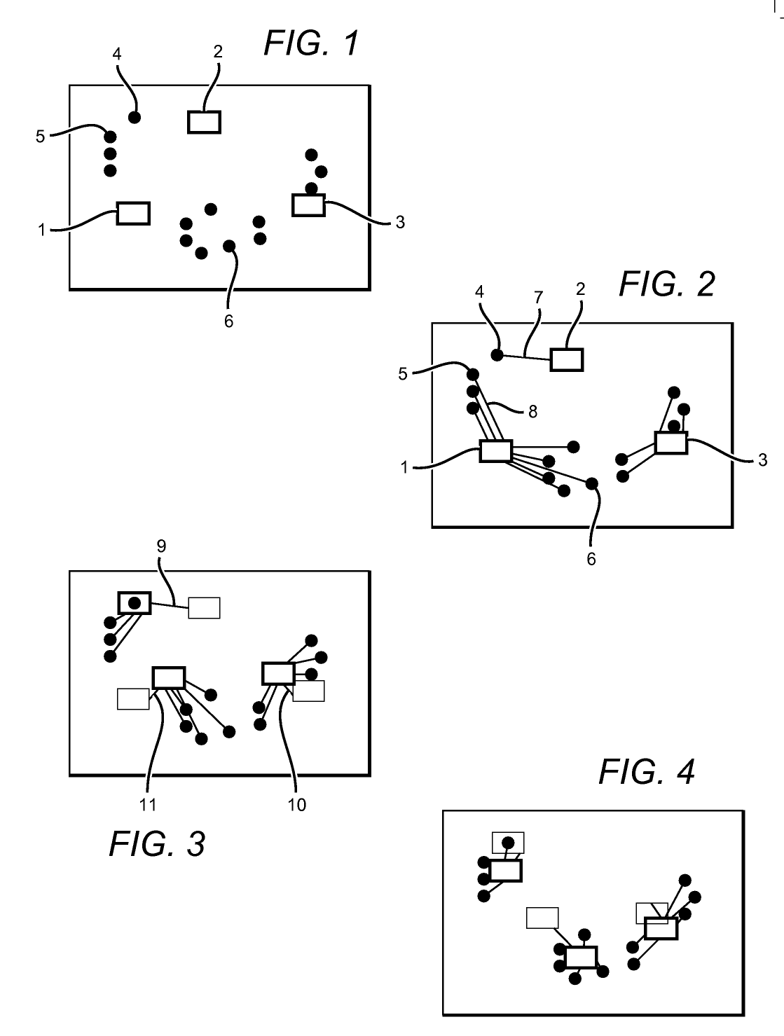

As shown in FIGS. 1, 2, 3, 4 and 7 some embodiments of the present invention utilize the K-Means clustering technique to optimize the positioning of test equipment switching units (SUs) 1, 2 and 3 relative to the UUT connectors as represented by the items 4, 5 and 6.

FIG. 1 represents an initial estimate as to the positioning of the SUs 1, 2, 3. While the initial positions are not critical, this placement will have an impact on the final results. In FIG. 2, the UUT connectors 4, 5, 6 are initially assigned to the nearest SU as represented by the connection lines 7 and 8. The determination of the nearest SU to a UUT connector is determined by calculating the straight line distance from the UUT connector to each SU using the following formula:

d=|xᵤₙ−xₛᵤₐ|+|yᵤₙ−yₛᵤₐ|+|zᵤₙ−zₛᵤₐ|

Where, d is the distance from UUT connector uₙ to switching unit suₐ, and x, y and z are the three dimensional coordinates.

Once all connectors are assigned to their nearest SU, each SU is moved to its respective centroid 9, 10, 11, or geographic center, of the group of UUT connectors assigned to it as shown in FIG. 3. The X-Y-Z coordinates of the centroid is determined by the formula:

$${X}_{C} = \frac{{\sum }_{u = 1}^{n} {x}_{u}}{n} {Y}_{C} = \frac{{\sum }_{u = 1}^{n} {y}_{u}}{n} {Z}_{C} = \frac{{\sum }_{u = 1}^{n} {z}_{u}}{n}$$

Where c is the centroid of a cluster of UUT connectors u₁ through uₙ. While the formula used in this embodiment equally weights each connector in the cluster, it is understood that other embodiments may assign weighted values to connectors based on the number of contacts within the connectors.

After the SUs are moved to the centroid of their respective connector clusters, the algorithm is repeated recursively. As shown in FIG. 3, various connectors may be reassigned to another SU. For example, connector 5 was assigned to one SU 2 in the first pass, but is now nearer to another SU 1. Because the total number of connectors in even the most complex UUT is small compared to the typical number of nodes analyzed by typical applications of K-means clustering, the algorithm processes each pass relatively quickly. Thus, a summary of the results of each pass of the algorithm may be presented, allowing the user to determine when enough passes have been performed in order to stop the process as shown in FIG. 4. The determination to stop the process may also be automatic based on a set number of iterations or objective criteria (i.e., the fulfillment of a condition). For example, a process may automatically continue until the distance from the current location of any SU to the centroid of its cluster of connectors does not exceed a minimal value. In any case, once the SUs are assigned to an acceptable position, a position map can be generated. The position map specifies the position of each SU within the fuselage relative to the UUT connectors. For example, the position map can be a visual representation of the location of the SUs throughout the fuselage, or it can be a data set representing the location of the SUs. The position map can be generated in an output module, for example. One embodiment of a method according to the previous description is shown in a flow chart in FIG. 7.

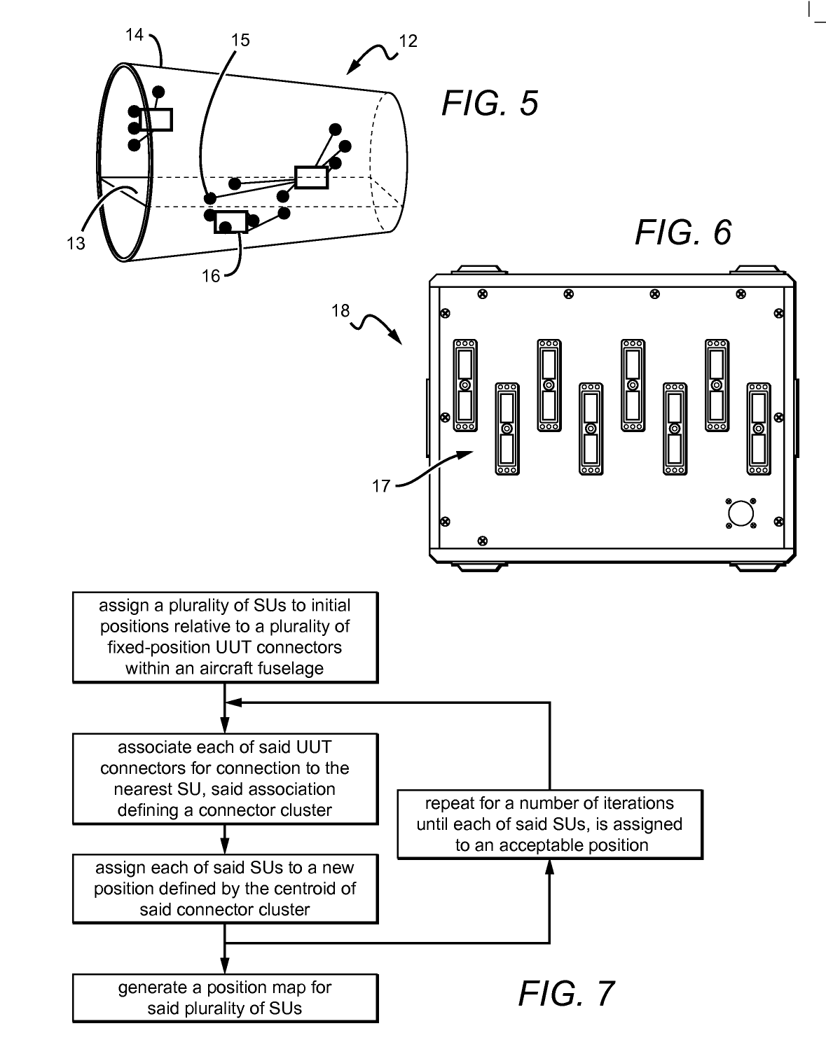

FIG. 5 illustrates that a typical UUT 12 may contain passenger floors 13, aircraft skin 14, and other physical barriers that block cables from connecting the UUT connectors 15 on one side of the barrier 13 to any SUs 16 on the opposite side of the barrier 13. The user may input the physical locations of barriers 13, 14 and may not include connectors on one side in the cluster associated with a SU on the opposite side. Given a simple barrier, such as barrier 13 (a floor), if the Y coordinate of an item 15 is greater than the Y coordinate of the barrier 13, then the item is above the barrier 13. If the Y coordinate of the item 16 is less than the Y coordinate of the barrier 13 then the item is below the barrier 13. There are four possible combinations of UUT connector 15 location and SU 16 location relative to such a barrier: 1) both below the floor; 2) the connector above the floor and the SU below the floor; 3) the connector below the floor and the SU above the floor and; 4) both above the floor.

In this particular embodiment, rather than making multiple comparisons of the Y coordinates to quickly determine if a specific UUT connector 15 is on the same side of the barrier 13 as a SU, the following simple formula is tested to be true:

((Yᵤ−Y_{b})*(Yₛᵤ−Y_{b}))≧0

where Yᵤ is the Y coordinate of the UUT connector, Y_{b} is the Y coordinate of the barrier (such as the passenger floor) and Yₛᵤ is the Y coordinate of the test system switching unit. If false, then the connector and the switching unit are on opposite sides of the floor. The formula represents a specific instance of the general case where a coordinate on one side of a barrier results in a negative number while a coordinate on the opposite side of the barrier results in a positive number. By multiplying the results of two such coordinate differentials together, if they are both on the same side of the barrier, the product will be positive; if they are on opposite sides, the product will be negative. By extension it can be seen that any complex barrier topology can be accommodated by simply replacing the subtractions in the formula with a more complex test of the locations relative to a barrier, where the mathematical sign (plus or minus) of the result indicates whether the two items are on the same or opposite sides of the barrier.

FIG. 6 illustrates the test adapter connectors of a typical switching unit 18 according to an embodiment of the present invention. In one embodiment, the SU provides eight ITT Cannon DL1-156 connectors 17. Each connector contains 156 contacts, 150 of which are connected to test switching for a total of 1200 test contacts in the complete unit. In such a case, if more than 1200 connections are assigned to the SU, then UUT connectors are reassigned to next nearest SU until the capacity of the current SU is no longer exceeded.

Embodiments of the invention also allow for a utilization factor to be included such that, for example, no more than 95% of the total physical capacity of the SU is utilized.

Although it is possible to manufacture a TAC cable that connects a single UUT connector across two or more SU connectors 17, this is not a desirable configuration. Therefore, where practical, the capacity of a single SU output connector 17, should not be exceeded. Thus, the algorithm is applied to the subset of UUT connectors assigned to each SU with the number of clusters being the number of SU test adapter connectors 17. In this way, the UUT connectors are assigned to the specific SU adapter connectors and the capacity of each adapter connector is not exceeded.

In one embodiment, the final distances between UUT connectors and SUs is calculated as the taxicab distance in order to better represent the physical constraints of routing electrical cables across floors and vertically rather than creating an inaccessible array of cables routed in all directions. This also allows for additional cable length that may be necessary to route around physical obstacles that might appear in the test environment.

Other embodiments of the present invention may include:

a method/system for calculating the placement of test equipment hardware in and/or around a unit under test (UUT), the use of element clustering algorithms, such as K-means, to assign specific nodes, or points to be tested, to the tester units;

a method/system wherein the lengths of the test adapter cables connecting the nodes of the UUT to be tested to the tester units are calculated based on taxicab distances rather than line of sight;

a method/system wherein the nodes which have the least impact on the total TAC cable length are reassigned to alternate tester units if the initial clustering algorithm assigns a greater number of nodes than the capacity of the first tester unit;

a method/system wherein physical barriers to making connections, such as floors, walls, bulkheads, etc., are data modeled and said data models are used to prevent the routing of test adapter cables through said barriers;

a method/system wherein a single test case is used to determine if the barrier impacts the routing between the UUT node and the tester unit through testing mathematical sign of the product of the difference between the barrier coordinates and the UUT node and tester unit coordinates;

a method/system wherein the assignment of UUT connectors to the test adapter connectors on the individual tester units is based on clustering techniques as used to assign the UUT connectors to the tester units as a whole; or

a method/system wherein the representation of the assignments are either by tables of data or by tables of data augmented by a graphical representation of the UUT connector and SU locations.

It is understood that embodiments presented herein are meant to be exemplary. Embodiments of the present invention can comprise any combination of compatible features shown in the various figures, and these embodiments should not be limited to those expressly illustrated and discussed. Although the present invention has been described in detail with reference to certain configurations thereof, other versions are possible. Therefore, the spirit and scope of the invention should not be limited to the versions described above.

I claim:

1. A method of determining the arrangement of a plurality of switching units (SUs) and a plurality of unit under test (UUT) connectors within a UUT, comprising:
(a) assigning a plurality of SUs to initial positions relative to a plurality of fixed-position UUT connectors within a UUT;
(b) associating each of said UUT connectors for connection to the nearest SU, said association defining a connector cluster;
(c) assigning each of said SUs to a new position defined by the centroid of said connector cluster;
(d) repeating steps (b) and (c) for a number of iterations until each of said SUs is assigned to an acceptable position; and
(e) generating a position map for said plurality of SUs.

2. The method of claim 1, further comprising determining a number of test adapter cables (TACs) necessary for connecting said UUT connectors with said SUs and the lengths of each of said TACs based on said position map.

3. The method of claim 1, further comprising arranging said SUs within said UUT according to said position map.

4. The method of claim 1, further comprising:
determining a maximum number of available connections in each of said SUs;
checking to see if the number of UUT connectors assigned to a given SU exceeds said maximum number of available connections; and
reassigning at least one UUT connector to the next nearest SU if said maximum number of available connections is exceeded for a given SU.

5. The method of claim 4, wherein said maximum number of available connections is defined by a utilization factor.

6. The method of claim 1, further comprising:
determining physical obstacles within said UUT;
reassigning any of said UUT connectors to a different SU if a connection between said UUT connector and said SU would be obstructed by any of said physical obstacles.

7. The method of claim 1, further comprising adjusting the location of said SUs to account for practical limitations.

8. The method of claim 1, wherein said number of iterations is predetermined.

9. The method of claim 1, wherein said number of iterations is determined by the fulfillment of a condition.

10. The method of claim 1, wherein for each of said UUT connectors the nearest of said SUs is determined using straight line geometry.

11. The method of claim 1, wherein for each of said UUT connectors the nearest of said SUs is determined using taxicab geometry.

12. The method of claim 1, wherein said UUT connectors are grouped according to named zones.

13. The method of claim 12, wherein UUT connectors within the same one of said zones are only assigned to a common SU.

14. The method of claim 1, wherein said UUT connectors are only assigned to SUs that are on the same side of a space relative to a physical obstacle.

15. The method of claim 1, wherein said position map comprises a graphical representation of a three-dimensional (3D) model.

16. The method of claim 1, wherein said position map comprises a coordinate data set.

17. The method of claim 1, wherein each of said UUT connectors is assigned a weighted value based on a number of contacts within said UUT connector, and wherein said weighted values affect the location of said centroid within a given of said connector clusters.

18. The method of claim 1, wherein said UUT comprises an aircraft.

19. A method for arranging at least two types of associated objects within a space:
(a) assigning a plurality of first-type objects to initial positions relative to a plurality of second-type objects within a three-dimensional (3D) space;
(b) associating each of said first-type objects with the nearest second-type object, said association defining an object cluster;
(c) assigning each of said second-type objects to a new position within said 3D space defined by the centroid of said object cluster;
(d) repeating steps (b) and (c) for a number of iterations until each of said second-type objects is assigned to an acceptable position; and
(e) generating a position map for said plurality of second-type objects.

20. A system for calculating the arrangement of a plurality of switching units (SUs) and a plurality of unit under test (UUT) connectors within a UUT, comprising:
an input module configured to accept input related to the position of said UUT connectors within said UUT and the initial position of each of said SUs within said UUT;
a calculation module configured to optimally rearrange said SUs within said UUT based on their relative position to said UUT connectors using an iterative process;
an output module configured to generate a position map describing the position of each of said SUs within said UUT.
